(19) United States
(12) Patent Application Publication
(10) Pub. No.: US 2005/0218810 A1
(43) Pub. Date: Oct. 6, 2005

(54) Efficient flat light source

(75) Inventors: Hoi-Sing Kwok, Hong Kong (CN); Yi Song, Shenzhen (CN)

Correspondence Address: BUCHANAN INGERSOLL PC;(INCLUDING BURNS, DOANE, SWECKER & MATHIS), POST OFFICE BOX 1404, ALEXANDRIA, VA, 22313-1404, US

(73) Assignee: SHENZHEN DICHENG TECHNOLOGY COMPANY LIMITED, Shenzhen (CN)

(21) Appl. No.: 10/815,674

(22) Filed: Apr. 2, 2004

(51) Int. Cl. H01J 17/16; H01J 61/35

(52) U.S. Cl. 313/635

(57) ABSTRACT

Disclosed here is an efficient flat light source based on UV light excited photoluminescence of phosphors. An electrical discharge is confined to be substantially planar by a glass enclosure. This electrical discharge produces ultraviolet photons. These UV photons in turn excite phosphors to produce visible light with great efficiency and high intensity. In this invention, light is taken out of the light source from one side only. A UV light recycling means is also provided. Means for collimation of this light source is disclosed for projection display applications. Polarization conversion means is also described for such flat light sources, so that the light output is almost totally linearly polarized.

### FIELD OF THE INVENTION

The present invention relates to the field of light sources, and in particular relates to flat or planar light sources based on the excitation of a phosphor by a low pressure gas discharge under the action of an alternating current.

### BACKGROUND OF THE INVENTION

Flat or planar light sources are useful for many applications such as in general lighting and backlights for liquid crystal displays (LCD). A flat light source is traditionally made of a linear light source such as cold cathode fluorescence light (CCFL) tube together with a flat (two-dimensional) light guide/diffusion layer to disperse the light in a plane from which light can be scattered out. A two-dimensional array of point sources such as tiny lamps and other sources such as light emitting diodes (LED) can also be regarded as a flat light source to a certain extent. U.S. Pat. No. 6,212,213, for example, describes a two dimensional LED array for the purpose of projection displays.

Field emission devices (FED) making use of electron beams inside a vacuum to excite a layer of phosphor can also be regarded as an alternate form of a flat light source. Even though FEDs were invented originally for display applications, they can also be used as an intense flat light sources for many applications. However, in a FED, good electrodes with high electron emitting efficiency and a high vacuum are needed. It should also be noted that the phosphor in a FED needs to be highly efficient in converting the energy of electron bombardment into visible light.

True planar light sources consisting of a pseudo-two-dimensional gas discharge and a phosphor layer are also known in the art. In order to maintain a uniform two-dimensional gas discharge, techniques such as barrier ribs, linear arrays, are used. U.S. Pat. No. 4,945,281 teaches a light source with an array of electrodes to excite a flat discharge. U.S. Pat. No. 6,628,066 describes a flat light source with spacer elements to separate individual discharges. In all cases, the resultant pseudo-two-dimensional gas discharge is then allowed to excite a phosphor as in an ordinary fluorescent lamp (FL). None of the inventions has optical elements to optimize the output of the light source in terms of polarization or recycling of rejected light or in collimation.

### SUMMARY OF THE INVENTION

According to the present invention there is provided a planar light source comprising: a glass cell comprising first and second glass walls, a low pressure gaseous mixture inside said glass cell, means for striking a gas discharge inside said gas cell, said gas discharge being capable of producing ultraviolet photons, optically reflecting coating on said first glass wall adapted to reflect visible light, a phosphor layer the first glass wall which is capable of converting ultraviolet photons into visible light, and an optical coating on the inside of the second glass wall which reflects substantially all ultraviolet light and transmits substantially all visible light.

In a preferred embodiment of the invention a sheet type reflecting polarizer may be placed on the outside of the second glass wall, this reflecting polarizer being adapted to reflect linearly polarized light of one polarization and to transmit linearly polarized light of a perpendicular polarization. More preferably still a quarter wave retardation plate may then be placed on an exterior surface of the second glass wall between the glass wall and the polarizer.

In order to increase the brightness of the planar light source, in a preferred embodiment of the invention a light scattering film may be provided on top of the reflecting polarizer that can limit the angle of emission of the light to be predominately in the forward direction.

The means for striking a gas discharge may comprise a pair of electrodes through the side of the said glass cell, or may comprise a radio frequency source located outside the said glass cell.

The gaseous mixture may comprise a mixture of inert gases and mercury or compounds of mercury, and preferably the light source may then further comprise a heating device for raising the cell temperature to above 30° C.

The phosphor layer may be continuous over the surface of the first glass wall, or may be patterned.

### BRIEF DESCRIPTION OF THE DRAWINGS

Some embodiments of the invention will now be described by way of example and with reference to the accompanying drawings, in which:

FIG. 1 shows a typical CCFL lamp according to the prior art,

FIG. 2 shows the cross section of the prior art CCFL lamp of FIG. 1,

FIG. 3 shows the geometry of the first embodiment of the present invention,

FIG. 4 shows further details of the embodiment of FIG. 3,

FIG. 5 shows a second embodiment of the present invention,

FIG. 6 shows a third embodiment of the present invention,

FIG. 7 shows a variation of the preferred embodiments, and

FIG. 8 shows the schematic diagram of the light angular distributions from the embodiments of the invention.

### DETAILED DESCRIPTION OF THE PREFERRED EMBODIMENTS

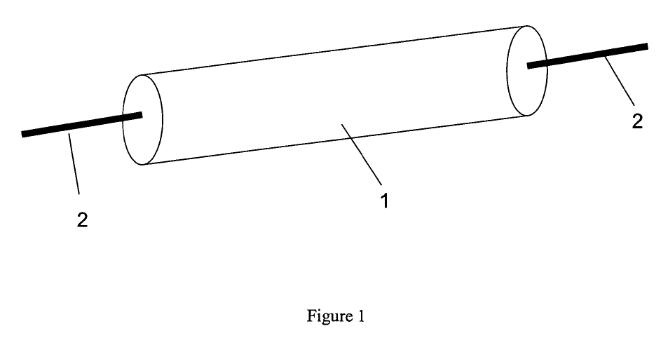

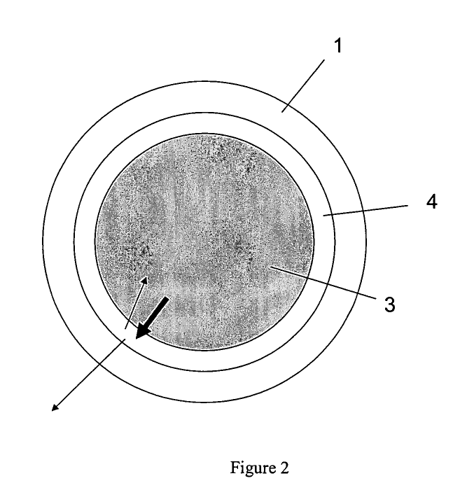

In a traditional cold cathode fluorescent lamp, the low pressure plasma discharge is confined in a cylindrical glass tube 1 (FIGS. 1 and 2). An electrical discharge is excited inside the tube by two electrodes 2. The discharge 3 emits ultraviolet light which excites the phosphor 4 which is coated on the inside of the glass tube 1. The phosphor emits visible light by the process of photoluminescence. This light has a spectral content that is controlled by the materials of the phosphor.

In a cold cathode discharge, it is important to choose the electrode materials appropriately so that electron emission is maximized for the voltages applied. In addition, it is also important to optimize the composition as well as the pressure of the gas inside the glass tube 1 so that a large amount of ultraviolet light can be generated with high efficiency. The literature has plenty of discussions of these issues and the art is well known. In a type of lamp where there are no electrodes, the plasma discharge is excited via a radio frequency source just outside the lamp.

In the present invention, at least in preferred forms, there is provided a plnar or flat light source based on a two-dimensional gas discharge and that is highly suitable for a range of applications such as in projection displays. Moreover, preferred embodiments of the invention provide means of increasing greatly the efficiency of the photoluminescence emission process from such gas discharges on the phosphor. Such light sources are truly planar and the light is emitted from one side of the light source only. This light source can then be collimated, as well as converted into linear polarization by various means for projection applications.

In all projectors, the image forming light valve is planar. The light source is traditionally a pseudo-point source such as an arc lamp. A planar light source of the type to be described below can be imaged directly onto such imagers with high efficiency, and the light on the imager can be imaged onto the projection screen by a projection lens. A flat light source is therefore ideal for projection applications.

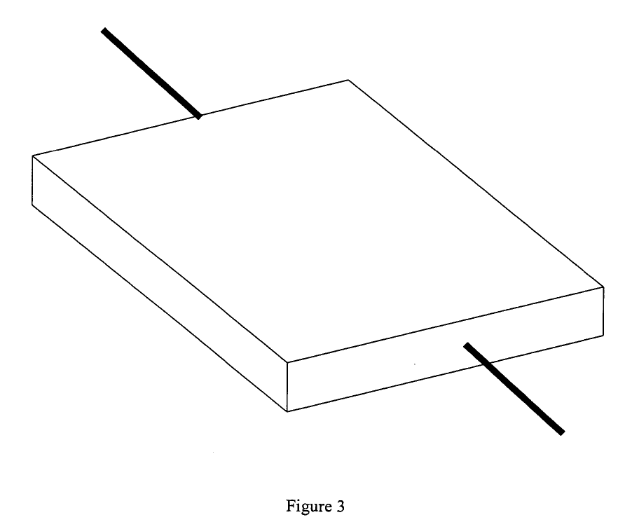

FIG. 3 shows the basic geometry of a light source according to an embodiment of the invention which has a flat structure. The lamp is substantially flat on both sides and has a rectangular geometry. Light is emitted only from one side of the lamp while the other side is opaque. The thickness of the lamp is optimized to give the highest light emission efficiency.

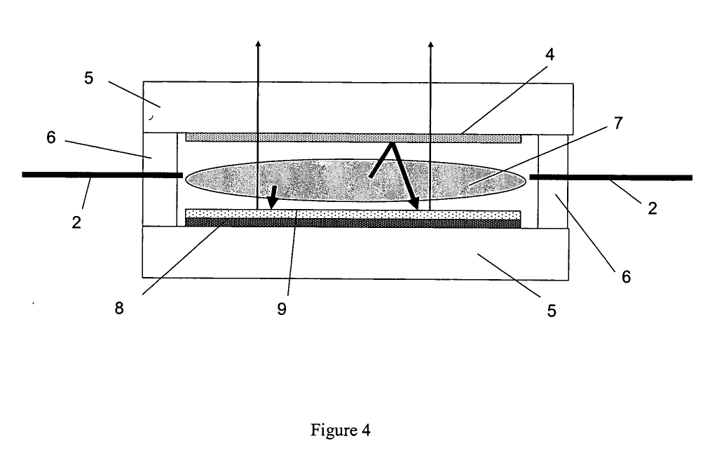

This flat geometry has many advantages. Firstly, since light is to be emitted from one side only, the opaque side can be coated with a totally reflecting mirror 8 (FIG. 4). This will direct all the light emitted from the phosphor to one side effectively. This reflecting coating 8 should preferably be dielectric so that it will not interfere with the electrical discharge.

Secondly, an important advantage of this CCFL flat light source is that the emitting phosphor faces the emitting side. This is very different from conventional tube type CCFL. As shown in FIG. 2, in a conventional CCFL, the inside of the phosphor is excited by the UV photons from the plasma discharge 3. The visible light emitted will have to go through the phosphor layer in order to escape to the outside. In the flat light source of the present invention, the visible light emitted is on the same side as the incident UV light. There is no scattering loss of the emitted visible light from the phosphor layer 9. For the light that escapes to the opposite side of the phosphor, the reflective mirror 8 is used to reflect it back to the correct side.

Thirdly, the flat light source can have enhanced efficiency by recycling of the UV light from the plasma discharge. Since UV light is emitted from the plasma discharge 3 in all directions, some UV light will go in the opposite direction of the phosphor layer 9. An optical coating 4 can be fabricated on the inside of the light source to reflect the UV light back into the phosphor layer 9. Hence all the UV light is utilized.

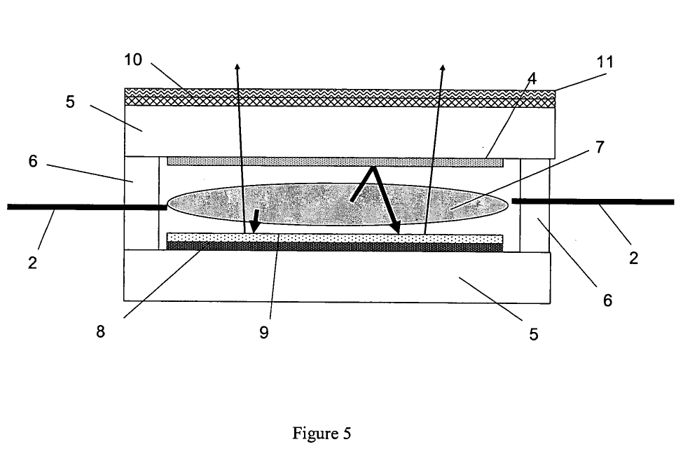

Fourthly, an optional polarization conversion film may also be included. The flat geometry of this light source makes it very simple in converting the polarization. The conversion is carried out by using a transmittive/reflective polarizing film 10 (FIG. 5) which has the property of transmitting light of a certain polarization direction and reflecting light of the perpendicular polarization. These films are available commercially such as those from 3M Company. This film will pass through light from the light source of one polarization only. Light of the wrong polarization will be reflected back into the phosphor. The scattering of the phosphor will give a depolarization effect and convert some of the light into the correct polarization which will be transmitted by the polarizing film 10. Hence eventually all of the light will be transmitted as one polarization. If necessary, a quarterwave film 11 can be placed underneath the polarizing film to rotate the polarization of the rejected reflected light from the polarizing film 10.

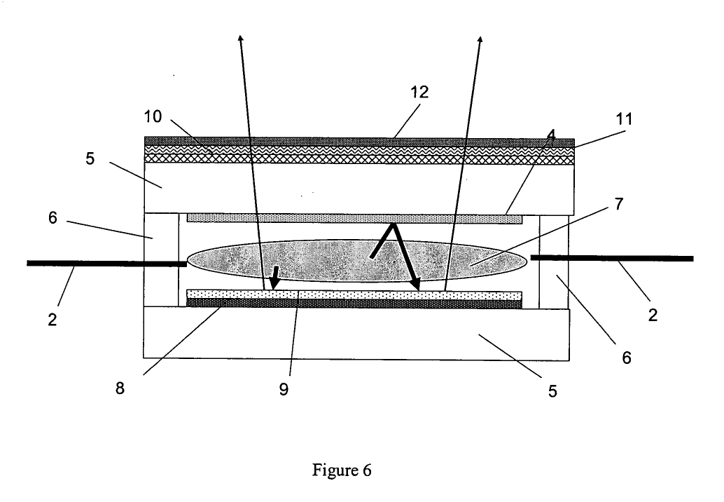

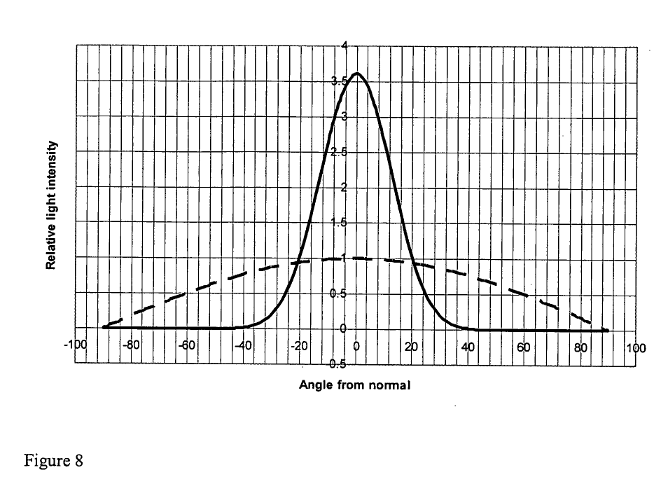

The angular distribution of the present planar light source is essentially Lambertian with a formula of
I(θ)=Iₒ cos θ
where θ is the angle form the normal. This distribution is shown as the dotted line in FIG. 8. One of the applications of embodiments of the present invention is as a light source for projection displays. For a flat light source, imaging optics can be used with high efficiency. In this case, it is necessary to use some sort of collimation films to confine the emission angle of the light from the light source. Such films can be in the form of “brightness enhancement films” (BEF) 12 (FIG. 6) from 3M Company. Alternatively a holographic scattering film 12 that scatters light predominately in the forward direction can be placed on the light source. The narrowed angular distribution, as shown as a solid line schematically in FIG. 8, is necessary to increase the light utilization efficiency in a projector. As a light source for a projector, the etundue E has to be as small as possible. The definition of E is
E=AΩ
where A is the area of the light source and Ω is the solid angle of the emission. Thus it is important to reduce Ω for projector applications. This can be accomplished by the use of diffuser films as indicated in this invention.

In the first preferred embodiment of this invention, the flat light source is composed of a rectangular cell made of glass with a shape as shown in FIG. 4. The cell is formed of generally parallel first and second glass walls 5 spaced apart by at least 0.5 mm. In the remainder of this description for convenience when referring to the drawings the first wall will be referred to as the lower wall, and the second wall will be referred to as the upper wall, but it will be understood that this lower/upper terminology is for convenience of description only. The walls 5 are generally flat and are held substantially at a fixed distance from each other by spacers 6. An optically reflecting coating 8 for all visible light is provided on the inner surface of the lower wall 5. On top of this coating is a provided layer of phosphor material 9 that is capable of converting ultraviolet light into visible light. On the inside of the top glass wall 5 there is provided an optical coating 4 that has the property of reflecting ultraviolet light and transmitting visible light.

In this first preferred embodiment, the plasma discharge can either be excited using a pair of electrodes 2, or by means of electrodeless discharge using an external circuit. The plasma discharge induced either by the electrodes or the external circuitry will produce ultraviolet photons. Very often the ultraviolet photons are produced by having mercury in the gas mixture, although this is not a requirement of the present invention. If mercury is used, however, the glass cell may have to be heated slightly (to above about 30° C.) to increase the concentration of mercury vapour and so an additional heating device may preferably be provided. The ultraviolet photons produced will impinge on the phosphor to produce visible light. Some ultraviolet photons may impinge on the phosphor directly, while some may first be reflected back by optical coating 4. Visible light generated from the phosphor layer in the direction of the upper glass wall is allowed to escape from the light source from the top surface, while visible light that leaves the phosphor layer in the opposite direction will be reflected by the reflecting coating 8 towards the upper surface where it may then leave the cell.

In the second preferred embodiment of the present invention, the construction of the flat light source is substantially the same as the first preferred embodiment except that a layer of reflective polarizer 11 is provided on top of the light source, as shown in FIG. 5. This reflective polarizer has the property of reflecting light of one polarization and transmits light of the perpendicular polarization. In addition, a quarterwave retardation film 10 can be used and placed underneath the reflective polarizer 11. This embodiment will allow only light of one polarization to be emitted and thus the light source emits only linearly polarized light with high efficiency.

In the third preferred embodiment of the present invention, an additional film 12 is placed on top of the light source. The purpose of the film is to limit the emission angle of the light so that it is predominately in the forward direction. There are several such films available in the market as “brightness enhancement films”. They can be structured surfaces such as the Vikuti™ film from 3M Company, or Light Diffuser Film™ holographic scattering films from Physical Optics Company.

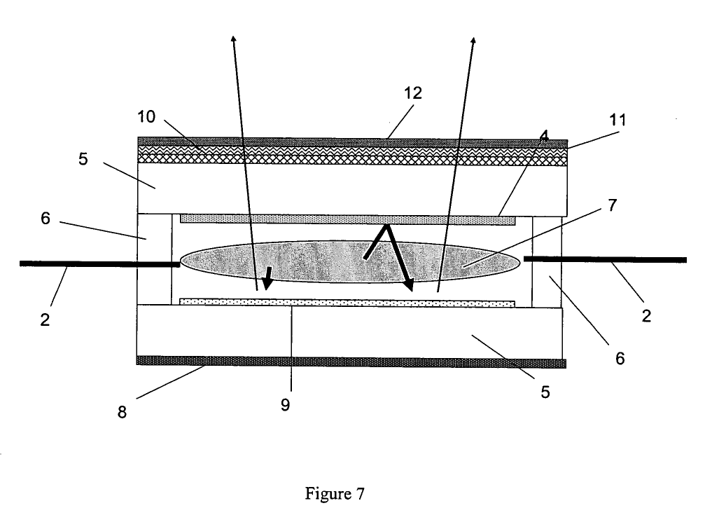

In all preferred embodiments, the placement of the light reflecting layer 8 can be either inside the glass cell or outside of it, as shown in FIG. 7.

1. A planar light source comprising:
(a) a glass cell comprising first and second glass walls,
(b) a low pressure gaseous mixture inside said glass cell,
(c) a means of striking a gas discharge inside said gas cell, said gas discharge being capable of producing ultraviolet photons,
(d) an optically reflecting coating on said first glass wall adapted to reflect visible light,
(e) a phosphor layer the first glass wall which is capable of converting ultraviolet photons into visible light, and
(f) an optical coating on the inside of the second glass wall which reflects substantially all ultraviolet light and transmits substantially all visible light.

2. A planar light source as claimed in claim 1 further comprising: a sheet type reflecting polarizer placed on the outside of the second glass wall, said reflecting polarizer being adapted to reflect linearly polarized light of one polarization and to transmit linearly polarized light of a perpendicular polarization.

3. A planar light source as claimed in claim 2 further comprising: a quarter wave retardation plate placed on an exterior surface of the second glass wall between said glass wall and said polarizer.

4. A planar light source as claimed in claim 3 further comprising: a light scattering film on top of said reflecting polarizer that can limit the angle of emission of the light to be predominately in the forward direction.

5. A planar light source as claimed in claim 1 wherein said means of striking a gas discharge comprises a pair of electrodes through the side of the said glass cell.

6. A planar light source as claimed in claim 1 wherein said means of striking a gas discharge in comprises a radio frequency source located outside the said glass cell.

7. A planar light source as claimed in claim 1 wherein said gaseous mixture comprises a mixture of inert gases and mercury or compounds of mercury.

8. A planar light source as claimed in claim 7 further comprising a heating device for raising the cell temperature to above 30° C.

9. A planar light source as claimed in claim 1 wherein the phosphor layer is continuous over the surface of the first glass wall.

10. A planar light source as claimed in claim 1 wherein the phosphor layer is patterned over the surface of the first glass wall.

11. A planar light source as claimed in claim 1 wherein the first and second glass walls are spaced apart by a distance of at least 0.5 mm.
